(19) United States
(12) Patent Application Publication
(10) Pub. No.: US 2008/0267753 A1
(43) Pub. Date: Oct. 30, 2008

(54) Method and Apparatus for Transporting a Cotton Module

(76) Inventor: Jimmy Ray Hargett, Bells, TN (US)

Correspondence Address: CARSTENS & CAHOON, LLP, P O BOX 802334, DALLAS, TX, 75380, US

(21) Appl. No.: 11/963,401

(22) Filed: Dec. 21, 2007

Related U.S. Application Data
(63) Continuation-in-part of application No. 10/852,822, filed on May 25, 2004, now abandoned.

(51) Int. Cl. B60P 1/38

(52) U.S. Cl. 414/507

(57) ABSTRACT

An improved method and apparatus for transporting a cotton module from the cotton field to a storage location. A conveyor apparatus is attached to the hitch of a tractor. The conveyor is operated by a hydraulic motor that is reversible such that the conveyor can be operated in both directions. To pick up a cotton module, the operator lowers the end of the conveyor close to the ground and backs under the cotton module while the conveyor is operated in a forward direction. Once the module is loaded onto the apparatus by the conveyor, the operator stops the conveyor and raises the conveyor for transportation to a desired location. To deposit the module, the operator lowers the apparatus to the ground and operates the conveyor in reverse while pulling the tractor forward at desirably the same speed as the conveyor.

### CROSS-REFERENCE TO RELATED APPLICATION

This application is a Continuation In Part and is entitled to the benefit of Non-Provisional patent application Ser. No. 10/852,822 titled “Method and Apparatus for Transporting a Cotton Module” filed on May 25, 2004 by inventor Jimmy Ray Hargett, the technical disclosure of which is incorporated herein by reference.

### 1. TECHNICAL FIELD

The present invention generally relates to cotton harvesting, and, more particularly, to a method and apparatus for moving a freestanding cotton module out of the field.

### 2. DESCRIPTION OF RELATED ART

The efficiency with which cotton is harvested and transported to the cotton gin has increased significantly since the cotton gin was invented. The increase in efficiency has been brought about in part by advances that have been made in mobile cotton harvesters. Some of the harvesters that are in use today include a large basket for holding the harvested cotton. When the basket is full, the cotton is transferred, or dumped, into a separate cotton module builder which tamps or compacts and shapes several basket loads of cotton from the mobile harvester into a large cotton module. Haney, et al., U.S. Pat. No. 4,184,425, disclose such a cotton module builder that utilizes a fluid operated tamper for compacting the cotton into a substantially freestanding rectangular shape. Although a cotton module can be formed in various sizes, a typical size is approximately 7½ ft. wide by 7½ to 8½ ft. high by 32 ft. long. Because the process of dumping multiple basket loads from the harvester into the cotton module builder is time and labor consuming, an improved cotton harvester has been developed. Covington, et al., U.S. Pat. No. 6,530,199, incorporated herein by reference, issued to Case Corporation, disclose a mobile cotton harvester with an integrated module builder. The harvester disclosed builds a cotton module that is approximately one half the length of a standard module. The module building capability of the mobile cotton harvester allows harvesting of the cotton and building the cotton into a cotton module to occur simultaneously so as to eliminate or reduce the steps required during harvesting of cotton and to eliminate the need for the traditional separate module builder. The cotton harvester disclosed by Covington, et al. thereby reduces the time and cost of harvesting cotton.

However, when the mobile cotton harvester is full, the operator must move the cotton harvester to the edge of the field to dump the cotton module so that it can be picked up by a module truck for transport to the cotton gin. The process of moving the cotton harvester to the edge of the field or to a storage location to dump a module reduces the amount of time that the cotton harvester can be in the field harvesting cotton. It would be more desirable if the operator of the mobile cotton harvester could dump the cotton module in the field at the location where the cotton harvester becomes full and continue with the harvesting operation.

Although improved module movers have been developed which have features such as track units to aid movement over soft, uneven, or wet ground, these module movers are generally too expensive or too complex to be used to move cotton modules out of the field. The prior art module movers are also cumbersome and time consuming to use. This is particularly true when the cotton gin is not yet ready to receive another module. Consequently, operators have typically either formed modules at the edge of the field or other desired location where the cotton module is stored until the cotton gin is ready to receive the module.

When using traditional module builders that are separate from the cotton harvester, the module builders are placed at the edge of the filed or other suitable location to build a module. Once one module is built, the module builder is lifted off that module and moved to an adjacent location to form another module. The cotton harvester makes multiple trips to the module builder to dump cotton in the process of building a module. Because the module is built at the location where it is stored until it is ready to go to the cotton gin, there is generally no need to transport the cotton module in the field when using a traditional module builder, although a module mover could also be utilized with traditional module builders to shorten the trips for the cotton harvester. Moreover, with the advent of a combined cotton harvester and module builder, there is now a greater need for a module mover that can efficiently transport the modules out of the field so that the cotton harvester can dump a module where it is completed in the field and continue harvesting cotton.

Without a module mover to move the modules out of the field, the operator may decide to dump an incomplete module prior to completing another pass over the cotton field to avoid stopping in the middle of the pass and returning to the edge of the field to dump the module. It would be more desirable and less time consuming if the operator were allowed to dump the cotton module in the field and continue harvesting cotton. However, currently there is not a method or apparatus that allows for the efficient transport of the individual cotton modules from the cotton field.

Therefore, there is a need for a method and apparatus to transport a cotton module from the field to the storage location or for pick up by a module truck. The apparatus should be capable of moving across a cotton field and should be simple, quick, and easy to use. The apparatus should also be capable of picking up a cotton module off the ground and depositing it on the ground in another location.

### SUMMARY OF THE INVENTION

The present invention increases the efficiency of cotton harvesting by allowing a mobile cotton harvester to dump a cotton module in the field for later transport to a storage or pick-up location. The present invention is a method and apparatus for transporting a cotton module from the cotton field to a storage location or other location as may be desired.

In one embodiment of the invention, a conveyor apparatus for picking up the cotton module is attached to the three-point hitch of a suitable tractor. In this embodiment, the conveyor is operated by a hydraulic motor which is connected to the remote hydraulic system on the tractor. The hydraulic motor is reversible such that the conveyor can be operated in both directions. To pick up a cotton module out of the field, the operator lowers the end of the conveyor down close to the ground and backs under the cotton module while the conveyor is operated in a forward direction. Once the module is loaded onto the apparatus by the conveyor, the operator stops the operation of the conveyor. He can then raise the cotton module to a transport position and transport the cotton module to a desired location. To deposit the module at the desired location, the operator again lowers the apparatus to the ground and operates the conveyor in a reverse direction using the remote hydraulic controls on the tractor. At the same time that he operates the conveyor in a reverse direction, he pulls the tractor forward at desirably the same speed as the conveyor.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a perspective view of a cotton module transporter in accordance with an embodiment of the present invention.

FIG. 2 is a side view of a cotton module transporter connected to a tractor showing various positions of the cotton module transporter in accordance with an embodiment of the present invention.

FIG. 3 is a side view of a cotton module transporter in a position for loading a cotton module in accordance with an embodiment of the present invention.

FIG. 4 is a side view of a cotton module transporter showing a cotton module being loaded onto the transporter in accordance with an embodiment of the present invention.

FIG. 5 is a side view of the cotton module transporter with a cotton module in a transport position in accordance with an embodiment of the present invention.

FIG. 6 is a perspective view of the cotton module transporter with hydraulic wheels for raising and lowering the transport modules in accordance with an alternate embodiment of the present invention;

FIG. 7 is a reverse angle view of the cotton module transporter with hydraulic wheels for raising and lowering the transport modules in accordance with the alternate embodiment of the present invention; and

FIG. 8 is another perspective view of the cotton module transporter without the side lever arms and second set of ground wheels in accordance with the alternate embodiment of the present invention.

### DETAILED DESCRIPTION

The above as well as additional features and advantages of the present invention will become apparent in the following detailed description. Unless otherwise noted, like numerals used in reference to the drawings are used to denote like parts.

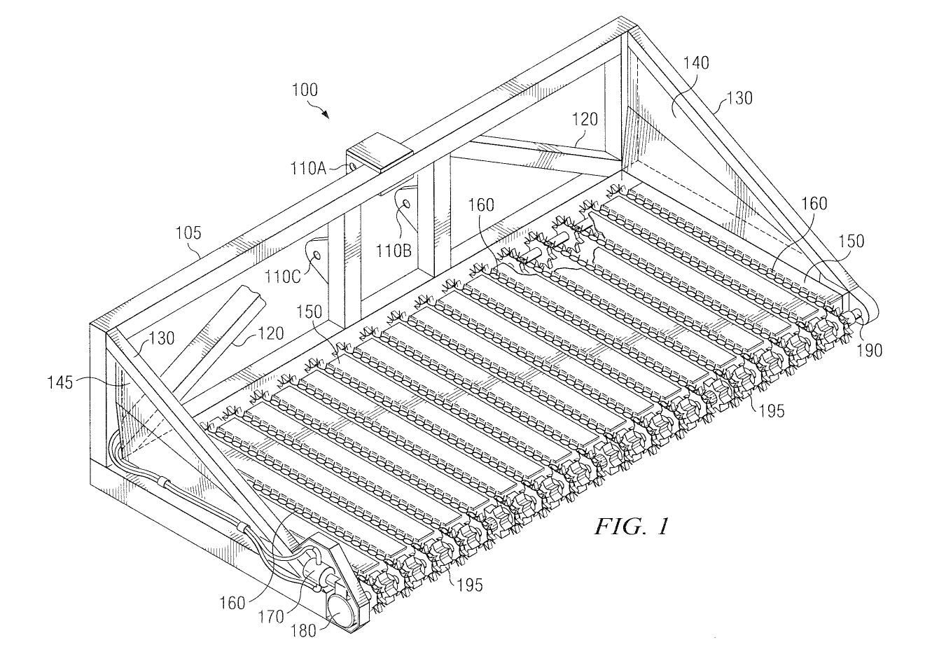

FIG. 1 is a perspective view of a cotton module transporter in accordance with an embodiment of the present invention. The transporter 100 is comprised of a frame 105 that is capable of supporting the weight of the cotton module to be transported. The frame 105 is configured with connection points 110A, 110B, 110C adapted for connection to the three-point hitch of a tractor that is capable of lifting the cotton module transporter with a cotton module loaded. In one embodiment of the invention, the frame 105 is comprised of 6 in. by 6 in. by ⅜ in. steel box frame. The diagonal members 120, 130 are comprised of 4 in. by 4 in. by ⅜ in. steel box frame. This structure with overall dimensions of approximately 19 ft. wide, 9 ft. deep and 5 ft. high has been demonstrated to be more than adequate to handle a 15,000 lb. cotton module. One with skill in the art will understand that the module transporter described herein could be made of different materials and different sizes without departing from the scope and spirit of the present invention. One with skill in the art will also understand that the module transporter described herein can be adapted to attach to the draw bar of a tractor or other equipment with hydraulically actuated wheels used to raise and lower the module transporter, such as, for example, wheel 601 depicted in FIG. 6.

Sheet metal steel side panels 140, 145 are attached to the frame and the diagonal members 130. The side panels 140, 145 are angled inward at the bottom side to help push the cotton module into a centered position if it is loaded off-center. The bed of the cotton module transporter is comprised of a series of steel panels 150 with slots in which a plurality of drag chains 160 run parallel to the bed of the transporter from front to rear. The drag chains 160 move in either direction along the bed to facilitate loading and unloading of a cotton module and are commonly known in the art. For example, a T-67 T-Rod chain available from Allied Lock Industries in Dickson, Ill. could be used.

The drag chains 160 are driven by a rotating drive shaft 190 which is connected to a reduction drive 180 which is connected to a reversible hydraulic motor 170 in a manner that is known in the art. The reduction drive 180 provides greater torque to drive the rotating drive shaft 190. A suitable reduction drive is a Model W260 with a 50:1 reduction ratio available from Superior Gearbox Company in Stockton, Mo. A suitable hydraulic motor is a Commercial Intertech “Parlyer Controls” 3.94 cu. in. reversible fixed displacement hydraulic motor. The hydraulic motor can be connected to the tractor through the remote hydraulic ports as is known in the art. Alternatively, a separate hydraulic pump can be attached to the tractor's PTO as is known in the art to provide hydraulic power to the hydraulic motor 170. The reduction drive 180 has two shafts including an input end to which the hydraulic motor 170 is attached and an output end which is attached to the drive shaft 190.

The rotating drive shaft 190 is comprised of drive sprockets attached to the shaft and star-shaped spider lifters 195 between each sprocket to aid in lifting the cotton module off the ground. Sealed bearings are placed between each sprocket and may be housed by a pillar block support or other commonly known bearing housing. Alternatively, the shaft 190 can be divided up into two or more separate shafts, each supported by bearings attached to the frame of the cotton module transporter. In this manner, if maintenance is required on one of the shafts, it is not necessary to remove all of the shafts in order to perform the maintenance. If more than one shaft is used, double sprockets can be used to connect one shaft to an adjacent shaft such that only one hydraulic motor 170 and reduction gear 180 is needed to drive all of the chains on the cotton module transporter. The invention is not limited to the particular conveyor system disclosed in FIG. 1. One with skill in the art will understand that there are a number of different types of chains and even other types of conveyor systems that can be used to move a cotton module onto and off of the cotton module transporter.

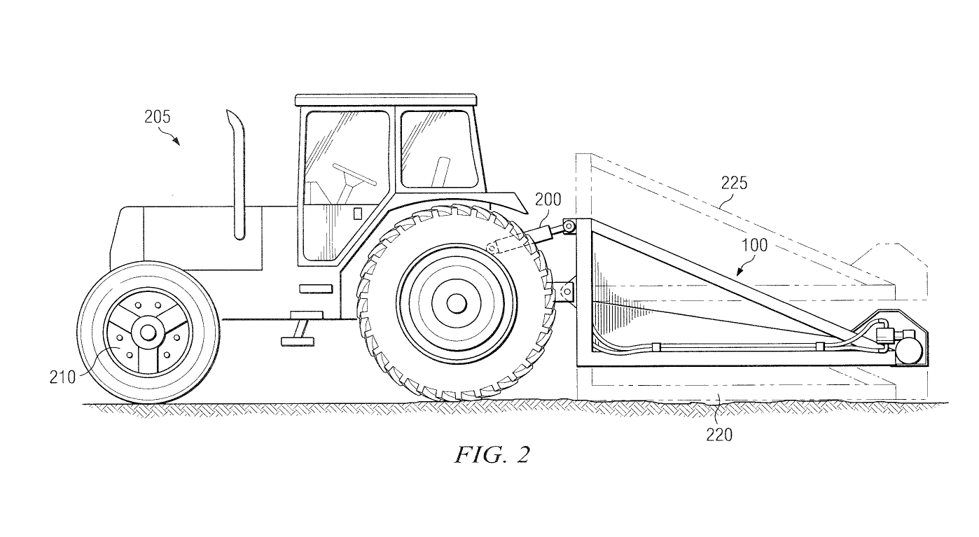

FIG. 2 is a side view of the cotton module transporter connected to the three-point hitch of a tractor in accordance with an embodiment of the present invention. The angle of the cotton module transporter relative to the ground can be changed using a remotely actuated hydraulic cylinder 200 connected as the top link on the three-point hitch. The tractor 205 should be large enough to handle the load placed on it by the cotton bales that are being transported. If necessary, ballast weight 210 may be attached to the front wheels of the tractor or to other locations on the tractor as is known in the art. The cotton module transporter 100 can be raised or lowered using the three-point hitch system of the tractor 205. FIG. 2 shows the cotton module transporter 100 at a mid-level position. The cotton module transporter can be lowered to the ground as shown in position 220 and can be raised up into a high position 225. The position of the cotton module transporter 100 will depend on the needs of the operator. For example, if the operator needs to load a cotton module onto the cotton module transporter, then he lowers the cotton module transporter to a position that is in close proximity to the ground. On the other hand, when transporting a cotton module, the operator raises the cotton module transporter to a transport position so that it does not touch the ground while the tractor is being moved from one location to the next.

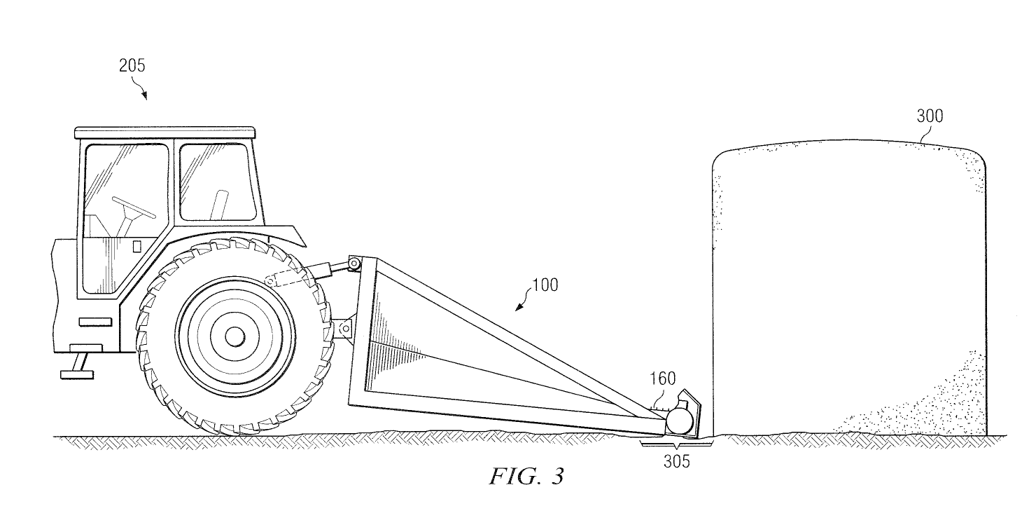

FIG. 3 shows a desirable position for loading a cotton module 300 onto the cotton module transporter 100 in accordance with an embodiment of the present invention, The operator of the tractor 205 lowers the cotton module transporter 100 to a position similar to that shown in FIG. 3. The rear end 305 of the cotton module transporter is placed in close proximity to the ground so that the conveyor system on the cotton module transporter 100 can work its way under the cotton module 300. Prior to backing the cotton module transporter under a cotton module, the operator of the tractor activates the hydraulic motor on the cotton module transporter such that the drag chains 160 move in a forward direction. The operator then backs under the cotton module 300 to load the cotton module onto the cotton module transporter. Ideally, the operator moves the cotton transporter in reverse at the same speed at which the drag chains 160 on the cotton module transporter are moving forward to avoid excessive mutilation of the cotton module 300 by the drag chains 160. Thus, if the operator loads the module in the most desirable manner, the cotton module stays in approximately the same horizontal location relative to the ground during the loading process.

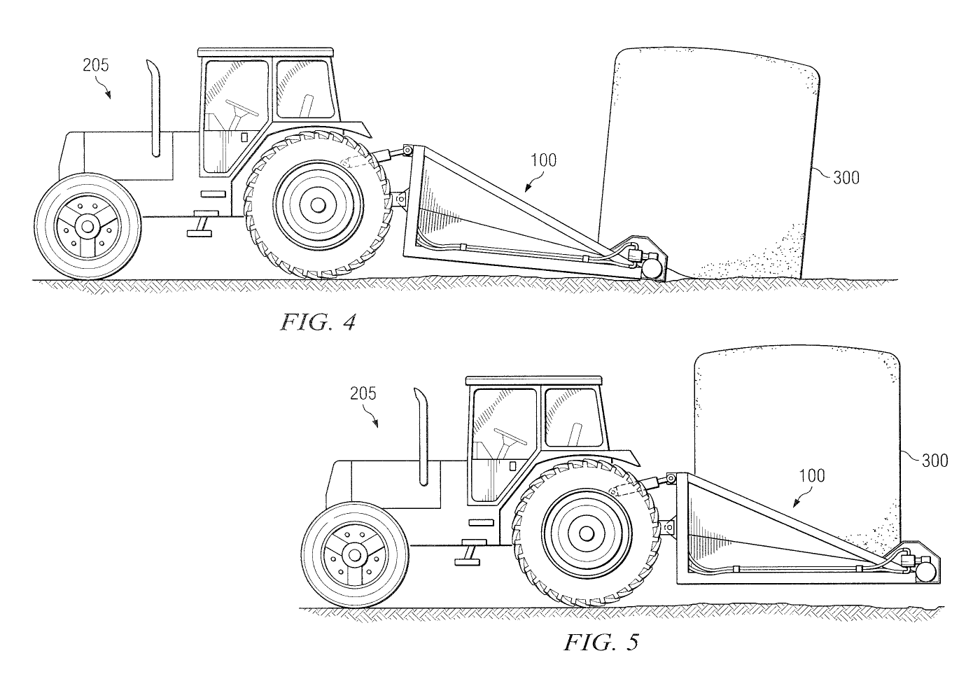

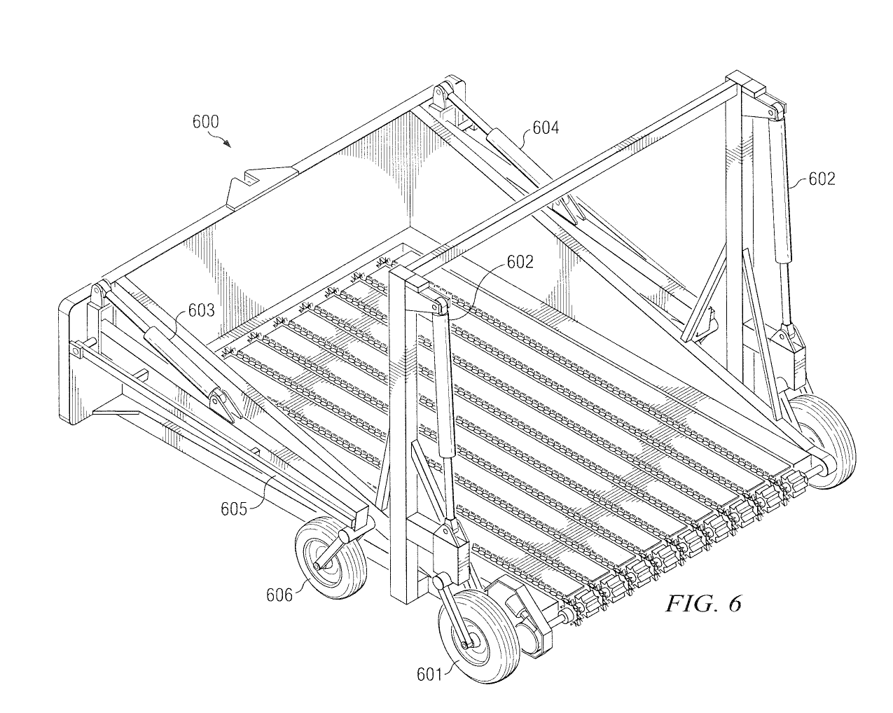

FIG. 4 shows the cotton module transporter 100 as it is being backed under the cotton module 300. Once the cotton module 300 has been completely loaded onto the cotton module transporter 100, the operator can raise the cotton module transporter to a transport position as shown in FIG. 5. At that point, the operator can transport the cotton module 300 to the desired location.

To unload the cotton module 300, the process is the reverse of the loading process. The operator lowers the cotton module transporter 100 in close proximity to the ground and actuates the hydraulic motor 170 in a reverse direction such that the cotton module is unloaded from the cotton module transporter. While the cotton module 300 is being unloaded, the operator pulls out from under the cotton module at a speed which is ideally the same as the speed as the drag chains 160 on the cotton module transporter 100.

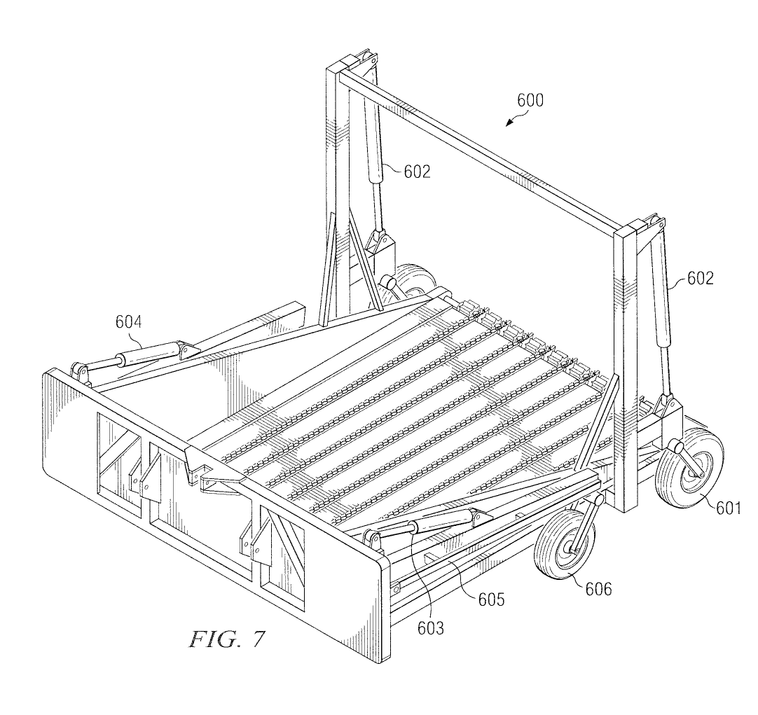

FIG. 6 is a perspective view of the cotton module transporter with hydraulic wheels for raising and lowering the transport modules in accordance with an alternate embodiment of the present invention. FIG. 7 is a reverse angle view of the cotton module transporter.

The cotton module transporter 600 in this embodiment of the present invention is longer and can accommodate a cotton module placed on its side. Due to the increased lever arm of the longer cotton module transporter 600 the tractor 205 might not be able to generate enough torque to lift the cotton module transporter with a loaded cotton module. Therefore, additional lifting force is provided by hydraulically actuated ground wheels 601 near the distal end of the cotton module transporter 600. As the hydraulic actuators 602 apply force to the ground wheels 601, the cotton module transporter 600 is lifted away from the ground. The ground wheels 601 also reduce the need for placing ballast weight at the front of the tractor 205.

The alternate embodiment also uses two remotely actuated hydraulic cylinders 603, 604 to change the angle of the cotton module transporter relative to the ground instead of only the single cylinder 200 used in the previous embodiment.

The proximal ends of the cylinders 603, 604 are coupled to the end of the cotton module transporter frame 600 as shown. The distal ends of the cylinders 603, 604 are coupled to side lever arms 605 that run along the side of the cotton module transporter 600. These lever arms 605 are also mounted on the end of the cotton module transporter 600. The other end of the lever arms 605 are coupled to a second set of ground wheels 606 positioned closer to the middle of the frame. Similar to the hydraulic actuators 602 at the end of the frame, the side cylinders 603, 604 can elevate and adjust the angle of the cotton module transporter 600 by applying force to side lever arms 605.

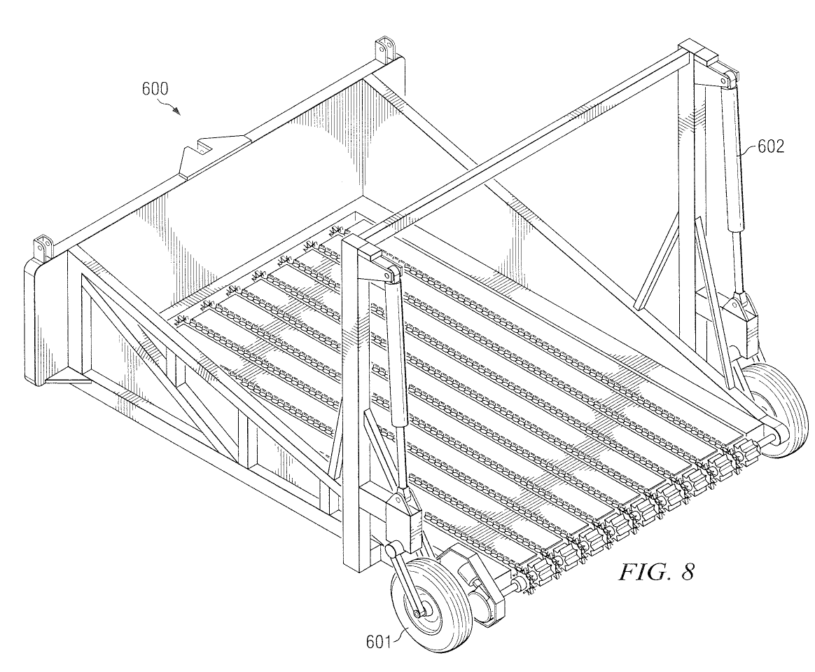

FIG. 8 is another perspective view of the cotton module transporter in accordance with the alternate embodiment of the present invention. In this configuration, the side lever arms 605 and second set of ground wheels 606 are missing. Elevation of the cotton module transporter 600 is provided by the ground wheels 601 and hydraulic actuators 602, and the angle of the transporter is controlled by a hitch mounted cylinder similar to cylinder 200 described above. The particular configuration of the invention used will depend on the needs of the user.

The above described cotton module transporter presents novel and non-obvious features that increase the efficiency of cotton harvesting. A cotton module transporter is described that is capable of satisfying the several objects of this invention. However, this invention should not be construed to be limited to the specific instruction elicited herein, but rather may be embodied in structure which change one or several of the disclosed features of the illustrated cotton module transporter. For example, the cotton module transporter could be used to transport other types of materials such as large bales of hay or round cotton bales. Different types of conveyors could be used and the transporter could be made of different sizes. It is to be understood that the invention is intended to cover all changes and modifications to the cotton module transporter as depicted herein, and all other embodiments not specifically illustrated, which do not constitute a departure from the true spirit and scope of this invention.

What is claimed is:

1. An apparatus for efficiently transporting a cotton module over a variety of terrain including terrain encountered in a cotton field, said apparatus comprising:
(a) a frame for receiving and lifting said cotton module wherein said frame is configured for connection to a tractor such that said tractor can provide a power source for said apparatus;
(b) a bed attached to a lower end of said frame for supporting said cotton module;
(c) a conveyor mated to said bed for loading said cotton module onto said bed and for unloading said cotton module from said bed wherein said conveyor can be operated in a forward direction to assist in loading said cotton module and can be operated in a reverse direction to assist in unloading said cotton module
(d) a first set of ground wheels mounted on the distal end of said frame; and
(e) hydraulic actuators coupled to both said frame and said ground wheels, wherein said hydraulic actuators adjust the height of the frame by applying force against the ground wheels, wherein said conveyor can be positioned in close proximity to ground level during said loading and said unloading.

2. The apparatus of claim 1 further comprising:
(f) two lever arms placed along either side of said frame, wherein the proximal ends of said lever arms are coupled to the proximal end of said frame and wherein the distal end of said lever arms are coupled to a second set of ground wheels on either side of said frame; and
(g) two hydraulically actuated cylinders mounted on either side of said frame, wherein the proximal ends of said cylinders are coupled to the proximal end of said frame and wherein the distal ends of said cylinders are couple to said lever arms, wherein said cylinders adjust the angle of said frame relative to said tractor by applying force against said lever arms.

3. The apparatus of claim 1 wherein said frame is configured for connection to a three-point hitch on said tractor.

4. The apparatus of claim 3 further comprising a hydraulically actuated cylinder for attachment as a top link on said three-point hitch such that an angle of said frame relative to said tractor can be adjusted during an operation of said apparatus.

5. The apparatus of claim 1 wherein said conveyor comprises a reversible motor for operating said conveyor.

6. The apparatus of claim 5 wherein said reversible motor comprises a hydraulic motor configured for connection to a remote hydraulic port on said tractor.

7. The apparatus of claim 6 wherein said reversible motor comprises a reduction drive having an input end attached to said hydraulic motor and an output end attached to a drive shaft on said conveyor such that when a hydraulic pressure from said remote hydraulic port is applied in a first direction to said hydraulic motor, said conveyor operates in said forward direction and when said hydraulic pressure from said hydraulic port is applied in a second direction to said hydraulic motor, said conveyor operates in said reverse direction.

8. The apparatus of claim 1 wherein said conveyor comprises a plurality of drag chains configured to operate in said forward and said reverse direction for assisting said loading and said unloading of said cotton module.

9. The apparatus of claim 8 wherein said conveyor comprises a plurality of lifters attached to an end of said conveyor for raising said cotton module off a surface during said loading of said cotton module.

10. The apparatus of claim 1, wherein said bed can support a cotton module placed on its side.
